(19) United States
(12) Patent Application Publication
(10) Pub. No.: US 2018/0247431 A1
(43) Pub. Date: Aug. 30, 2018

(54) PROCESS, SYSTEM AND APPARATUS FOR MACHINE COLOUR CHARACTERISATION OF DIGITAL MEDIA

(71) Applicant: QUIVERVISION LIMITED, Auckland (NZ)

(72) Inventors: Adrian CLARK, Wellington (NZ); Julian LOOSER, Wellington (NZ)

(21) Appl. No.: 15/754,052

(22) PCT Filed: Aug. 21, 2016
(86) PCT No.: PCT/NZ2016/050132

§ 371 Date: Feb. 21, 2018

(30) Foreign Application Priority Data
Aug. 21, 2015 (AU) 2015903393

(51) Int. Cl. G06T 7/90; G06K 9/46; G06K 9/00; G06T 19/00

(52) U.S. Cl. CPC G06T 7/90; G06K 9/4652; G06T 2207/10024; G06T 19/006; G06K 9/00671

(57) ABSTRACT

Aspects of the present invention provide machine colour characterisation for augmented reality. A process of machine colour characterisation for digital images comprises generating colour model data for each of a set of colour categories dependent on colour captured in example digital media from example colours in an example image, the colour model data for each colour category defining a constraint in a colour space. The constraint is defined dependent on a set of example pixels of the example digital media, and the process comprising relating pixels of the image to be characterised to the constraint of one or more colour models to identify colour categories for the pixels of the image to be characterized to characterise the digital image. A transformation is computed for a mean of the example pixels expressed using colour components to the origin of the R, G, B cube and transforms one or more axes determined for the pixels to align with R, G or B axes. A constraint may be defined as a first bounding volume. The bounding volume may be a bounding volume corresponding to ranges of example pixels of one example colour in the R, G, B cube.

### FIELD OF THE INVENTION

The present invention relates to a process, system and apparatus for machine colour characterisation of digital media: such as recognising colours in a digital or video stream; such as a method, system and apparatus for controlling applications or the generation of media dependent on colour information in input media, and such as a process, system and apparatus for controlling augmented reality applications or generating digital media for augmented reality dependent on colour information in input media.

### BACKGROUND OF THE INVENTION

Applications for computers or mobile devices and systems for media generation are becoming increasingly interactive and are generating increasingly rich media. One type of application provides a user with an augmented reality which combines media generated by an application with media captured from the environment of the user.

Some augmented reality applications use input media, such as a captured image or video stream, to generate media. There is limited conventional ability for applications to use to use information on colour in input media. In particular, there is limited conventional ability for augmented reality applications to use information on colour included in images or video input to the application.

It is an object of the present invention to overcome limitations in conventional use of colour information by applications or for the generation of media, or at least to provide the public with a useful choice.

It is an object of the present invention to provide a means for a user to control augmented reality applications or for the generation of media, or at least to provide the public with a useful choice.

As used herein the term ‘volume’ refers to a 3-D region, and includes volumes and regions defined with arbitrary axes and includes mathematically defined volumes or regions.

### DISCLOSURE OF THE INVENTION

Aspects of the present invention provide a process for machine characterisation of colour, the process comprising:

receiving colour model data for each of a set of colour categories, the colour model data generated dependent on example colour data for each of a set of colour categories;

receiving data capturing a subject image for colour characterisation;

relating one or more units of data capturing the subject image to the colour model data of the set of colour categories to determine a colour category for the unit of subject image.

This aspect of the invention allows arbitrary colours captured in example colour data to be defined as colour categories. The defined colours will then be represented by colour model data to allow colour in subject images to be characterised. The use of example images capturing example colour data to generate colour model data for the colour categories allows a user to train the system to recognize arbitrary colour categories.

Units of subject and/or example images may be pixels to provide example pixels for each of the colour categories.

The colour model data may be defined using colour component axes.

The colour model data may comprise a volume defined using colour component axes of a colour space.

The volume may comprise a volume defined so as to contain the example pixels for each of the colour categories.

The volume may be a box bounding the example pixels of a colour category.

The volume may comprise a volume defined so as to contain a defined subset of the example pixels for each of the colour categories. The volume may be a box bounding a defined subset of example pixels of a colour category.

Relating the subject images to the colour model data may comprise relating colour components of the unit of data from the subject image to the colour model defined using colour component axes.

Colour components may be red, green and blue components of pixels.

Colour model data may be a mean of pixels expressed using red, green and blue colour components of a set of pixels of one or more example images.

A colour model feature may be a volume defined in a colour space dependent on a sample of pixels expressed in the colour space.

Aspects of the present invention provide a process of machine colour characterisation for digital images, the process comprising generating colour model data for each of a set of colour categories dependent on colour captured in example digital media from example colours in an example image, the colour model data for each colour category defining a constraint in a colour space, wherein the constraint is defined dependent on a set of example pixels of the example digital media, and the process comprising relating pixels of the image to be characterised to the constraint of one or more colour models to identify colour categories for the pixels of the image to be characterized to characterise the digital image.

The process may comprise computing a transformation which transforms a mean of the example pixels expressed using colour components to the origin of the R, G, B cube and/or transforms one or more axes determined for the pixels to align with R, G or B axes.

A constraint may be defined as a first bounding volume. The bounding volume may be a bounding volume corresponding to ranges of example pixels of one example colour in the R, G, B cube.

A constraint may be defined as a second bounding volume. The bounding volume may be proportion or confidence interval or a statistical measure, such as standard deviations, of example pixels relative to their mean of one example colour in the R, G, B cube.

The process may also comprise mapping a pixel of digital media to be characterised using the transformation defined by the colour model.

The reference colour space that pixels occupy may be the R, G, B cube.

The transformation may map a mean of a set of example pixels to the origin of the R, G, B cube.

Colour models may be defined for a set of colours captured by example digital images each containing different example colours.

Colour categories may be defined by a user adding a chosen colour to an image and capturing digital media used to generate a colour model.

A colour model may be defined using a set of example digital images each containing examples of the same colour to be characterised.

The pixels of images to be characterised may be mapped using the transformations of each of the colour models.

The pixels of images to be characterised may be related after mapping to constraints of each of the colour models.

A constraint may comprise a bounding volume in defined in the R, G, B cube.

A constraint of colour model may comprise a bounding volume defined so as to contain substantially all of the example pixels used to generate a colour model.

A constraint of a colour model may also comprise a bounding volume defined so as to define a proportion or probability or confidence interval of a distribution of the example pixels used to define the colour model. This may be one standard deviation of a distribution fitted to the example pixels.

The process may comprise determining whether a pixel of an image to be characterised is contained in one or more of the bounding volumes of a single colour model.

The process may comprise calculating distances from the pixel of the image to be characterised to defined points of constraints in the reference colour space and selecting the minimum distance to determine a colour category for the pixel.

The process may comprise defining linearly uncorrelated axes for the example pixels to define a first colour space and then computing a transformation matrix suitable to map the linear uncorrelated pixels to a standardised colour space.

The transformation matrix computed may further map a colour component mean of the example colour pixels to the origin, or other defined point, of the standardised colour space. The standardised colour space may be a space standardised for a set of colour models and/or a set of characterisations of colour and/or a colour model and a colour characterisation.

The standardised colour space may be the R, G, B colour space in which X,Y and Z axes correspond to R, G and B components.

Aspects of the present invention provide a process of recognising colours from a set of example colours by capturing the example colours in example media data, generating colour model data for each example colour the model comprising a constraint for each example colour and a transformation from a colour space defined by the media data capturing each colour to a reference colour space, whereby media data in which colours are to be recognised can be transformed to the reference space using the transformation of each example colour and related to the constraint defined for each colour to recognise the colour corresponding to the constraint.

Aspects of the present invention provide a process of recognising colours from a set of example colours by capturing the example colours in media data, generating colour model data for each example colour, the colour model comprising a constraint for each example colour, whereby media data in which colours are to be recognised can be related to the constraint defined for each example colour to recognise one of the colours.

In one aspect the invention provides a process of generating colour model data for an example or selected colour for use in machine recognition of colours, the process comprising:

receiving example media data carrying example colour information for an example image;

computing colour components of units of the media data to store each unit as colour components;

defining axes for the stored units to define a first colour space;

computing a transformation from the colour space to a standardised colour space;

defining a constraint in the standardised colour space dependent on the stored units;

colour model data carrying information on the bounding volume and a matrix transforming the first colour space to the standardised colour space as colour data model generated from the example media data.

The axes defined for stored units may be linearly uncorrelated.

The process may comprise storing colour model data carrying information on the mean value of the colour components,

The constraint may be a bounding volume.

The colour components calculated may be red, green, blue colour components.

The mean value of the colour components may be determined by summing the values of red, green and blue of the units of input media and dividing by the count of the units.

The transformation may map the uncorrelated axes to axes of the standardised colour space and maps a mean value of the colour components of the units of media data to the origin of the standardised colour space.

The units of media data may be pixels.

The process may comprise capturing media data carrying information on a collection of example images each comprising an example capture of the same example colour and storing colour categorisation for each of the example colour from the collection of example media data.

The process may comprise capturing media data carrying information on a set of example images each containing example colours and storing colour categorisation data for each of a the example colours to provide a set of colour model data to use in machine recognising of a set of different colours.

In one aspect the invention provides a process of machine categorisation of colours in an image, the process comprising the steps of:

receiving one or more colour model data defined by the process of any one of the paragraphs above,

receiving media data carrying colour information for the image;

calculating colour components for units of the media data;

applying a transformation defined in the colour model data to the colour components to map the units of media data to the standardised colour space as stored coordinates;

relating the units of media data stored as coordinates in the standardised colour space to the constraint or bounding volume of one or more colour models to identify a colour category for the units.

The process may comprise identifying colour categories for a number of units in a defined region of the image.

The defined region may be selected as a region in a reference image.

The reference image may be two dimensional and have one of more regions associated with one or more respective regions on a 3-D model or avatar.

A process of controlling an application comprising the step of invoking one or more actions in response to a colour category being identified in the image.

The actions may be selected from a set of actions associated with given regions the 2-D reference image.

The actions may be selected from a set of actions associated with given regions the 3-D model or avatar.

A process of controlling an application running on a computer system, the application operable to generate data for media, the process comprising:

reading categorisation data defining a categorisation model comprising a bounding volume defined in a colour space dependent on the example pixels received in an example data deed which captures colour information from an image comprising example colour, the example pixels expressed in the colour space, the bounding volume having a defined probability of containing the example pixels in the colour space assuming a given distribution of pixels in the colour space;

receiving control pixels in a control data feed to capture colour from a control image;

categorising one or more control pixels dependent on the bounding volume; and

invoking a defined action in the application dependent on one or more or the categorisation of the one or more control pixels.

The categorisation model may have been defined by a process comprising finding mean red green blue values of all of the for the example pixels collectively per colour.

The categorisation model may have been defined by a process comprising determining a transformation matrix to transform the distribution of example pixels to a standardised Red, Green, Blue coordinate system.

The transformation matrix may be operable to position the red green blue mean of the example pixels at the origin of the standardised red green blue coordinate system.

Categorising the one or more control pixels may comprise determining whether the control pixels are bounded within a maximal bounding volume. This determination may be after operation on the pixels in colour space using the transformation matrix.

The maximal bounding volume may comprise a volume which contains each of the example pixels.

Categorising the one or more control pixels may comprise determining whether the control pixels are bounded by only a first probabilistic bounding box.

The probabilistic bounding box may be defined by 1 standard deviation from the mean read green blue of the example pixels.

The determination whether the control pixels are bounded by only a first probabilistic bounding box may be after operation on the pixels in colour space using the transformation matrix.

The first bounding volume may be defined by a first set of example pixels and correspond to a first example colour.

Categorising the one or more control pixels may comprise determining the minimal distance between the pixel and the mean red green blue of a set of example pixels. Determining the minimal distance between the pixel and the mean red green blue of a set of example pixels may be after operation on the pixels in colour space using the transformation matrix.

Defining a categorisation model may comprise expressing the example-colour pixels using colour components. These components may be red green and blue components.

Defining a categorisation model may comprise defining principle, secondary and tertiary axes for the example-colour pixels expressed using colour components. These axes may be defined to correspond to the longest dimension of the colour-example pixels, second longest dimension of the colour-example pixels and a dimension that is orthogonal to these dimensions in 3-D space respectively. The axes maybe defined using principle component analysis.

Defining a categorisation model may comprise defining a transformation mapping the principle, secondary and tertiary axes to standardised colour component space and mapping a mean of the colour-example pixels to the origin of the colour component space.

Defining a categorisation model may comprise defining the maximal bounding volume having dimensions which correspond in the standardised colour space to the greatest value of the transformed example-pixels along each dimension in the standardised colour space.

The process of invoking an action in the application running on a computer system may comprise storing categorisation data describing the categorisation model.

The process of controlling an application running on a computer system may comprise receiving example-colour pixels and defining a categorisation model and storing the categorisation data on a server for use by applications running remotely to be controlled by receiving control pixels and categorise colours using the categorisation data.

The process of controlling an application may comprise receiving example-colour pixels captured for a set of example colours and generating categorisation data from the set of example colours to enable categorisation of control colours into a number of colour categories.

The process may comprise associating colour categories with defined control actions used to control the application.

Controlling the application may comprise controlling generation of data for media.

The data for media may be generated using a 3-D model or avatar.

Another aspect of the present invention provides a process of generating colour categorisation data identifying one or more recognisable colour categories in captured media data, the process comprising:

storing captured units of captured media data using coordinates of a colour space;

associating a recognisable colour with the captured unit dependent on one or more bounding volumes defined for each recognisable colour which may bound the unit in the colour space.

The process may comprise associating a colour category dependent on two or more bounding volumes defined for each recognisable colour and within which the unit may be bounded in the colour space.

The process may comprise associating a colour category dependent on the distance in colour space between a mean for the unit and means in colour space for a set of candidate recognisable colours. The colour with a colour component mean that is computed as a minimum distance to the mean of the unit may be associated with the unit.

The process may comprise applying a transformation to the unit in colour space and then relating the unit in colour space to one or more bounding volumes.

The standardised colour space may be the red green blue colour space.

The units of captured media may be pixels.

Aspects of the present invention provide a process of controlling an application or the generation of media by capturing a digital image, characterising colours of selected areas in the image, and invoking actions in the application associated with the selected areas.

The areas may be selected by associations between areas of a 2-D reference image and parts of a 3-D model or avatar.

The actions invoked may be associated with given parts of the 3-D model or avatar.

Aspects of the present invention provide a process of controlling an application or the generation of media by capturing a digital image, characterising colours of example areas in the image, and invoking actions in the application associated with parts of a 3-D model associated with areas of a 2-D diagram captured in the image.

Another aspect of the present invention a process for transforming data storage meda carrying colour data captured in a subject digital image to data storage media carrying colour characterisation data which characterizes colour in the captured subject image, the process comprising:

receiving example colour data for each of a set of colour categories, the colour data captured in example images;

generating colour model data for each colour category dependent on the example colour data for the respective colour category;

receiving a subject image for colour characterisation;

relating one or more units of data from the subject image to the colour model data of the set of colour categories to determine a colour category for the unit of subject image; and

storing colour characterisation data identifying the colour category determined.

Aspects of the present invention comprise a processor operable to perform one or more algorithms dependent on colour characterisation data.

Aspects of the present invention provide a processor operable to initiate one or more events dependent colour characterisation data.

Aspects of the present invention provide a processor operable to be responsive to colour data received in subject images dependent on any one of the processes above.

Aspects of the present invention comprise a processor operable to read storage media carrying subject image data and to write characterisation data to storage media using any one of the processes above.

In one aspect the present invention provides a computer system operable to generate colour model data for an example colour or selected colour for use in machine recognition of colours, the process comprising:

an example media interface operable to receive data carrying example colour information for an example image;

a colour component module operable to compute colour components of units of the media data to store each unit as colour components;

an axis module operable to define component axes for the stored units to define a first colour space;

a transformation module operable to computing a transformation from the colour space to a standardised colour space;

a constraint module operable to define a constraint in the standardised colour space dependent on the stored units;

a colour model module operable to generate colour model data carrying information on the constraint and a carrying information on a matrix transforming the first colour space to the standardized colour space.

In one aspect the present invention provides a computer system operable to characterisation colour comprising:

a colour model data interface operable to receive colour model data for each of a set of colour categories, the colour model data generated dependent on example colour data for each of a set of colour categories;

a subject image interface operable to receive data capturing a subject image for colour characterisation; and

a categorization interface operable to relate one or more units of data capturing the subject image to the colour model data of the set of colour categories to determine a colour category for the unit of subject image.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1 illustrates a process of generating colour model data used to characterise colour information in pixels according an embodiment of the present invention;

FIG. 2 shows a page to be captured in a reference image to capture colour data for three colour categories according to an embodiment of the present invention;

FIG. 3 shows a part of an example image capturing colour data for one colour category according to an embodiment of the present invention;

FIGS. 4a and 4b show example pixels from the part of an example image shown in FIG. 3 expressed using R, G, B components according to an embodiment of the present invention;

FIGS. 5a and 5b show the mean of example pixels for a colour category from the image of FIG. 3 expressed using R, G, B components according to an embodiment of the present invention;

FIGS. 6a and 6b show a primary axis, from PCA analysis, of example pixels for a colour category from the image of FIG. 3 expressed using R, G, B components according to an embodiment of the present invention;

FIGS. 7a and 7b show a secondary axis, from PCA analysis, of example pixels for a colour category from the image of FIG. 3 expressed using R, G, B components according to an embodiment of the present invention;

FIGS. 8a and 8b show a tertiary axis, from PCA analysis, of example pixels for a colour category from the image of FIG. 3 expressed using R, G, B components according to an embodiment of the present invention;

FIGS. 9a and 9b show example pixels for a colour category from the image of FIG. 3 expressed using R, G, B components and transformed so that the principle, secondary and tertiary components lie along an axes of the R, G, B cube according to an embodiment of the present invention;

FIGS. 10a and 10b show example pixels for a colour category from the image of FIG. 3 expressed using R, G, B components and transformed so that the principle, secondary and tertiary components, which are shown, lie along an axes of the R, G, B cube according to an embodiment of the present invention;

FIGS. 11a and 11b show a maximum bounding box for example pixels for a colour category from the image of FIG. 3 expressed using R, G, B components and transformed so that the principle, secondary and tertiary components, which are shown, lie along an axes of the R, G, B cube according to an embodiment of the present invention;

FIGS. 12a and 12b show a maximum bounding box and 1 standard deviation bounding box for example pixels for a colour category from the image of FIG. 3 expressed using R, G, B components and transformed so that the principle, secondary and tertiary components, which are shown, lie along an axes of the R, G, B cube according to an embodiment of the present invention;

FIGS. 13a and 13b show example pixels for a colour category from the image of FIG. 3 expressed using R, G, B components and show primary, secondary and tertiary components and mean and maximum bounding box and 1 standard deviation bounding box as they would appear prior to transformation according to an embodiment of the present invention;

FIGS. 14a and 14b show example pixels for all three colour categories captured from the reference page of FIG. 2, or a corresponding captured image of it, prior to PCA and transformation according to an embodiment of the present invention;

FIGS. 15a and 15b show example pixels from the image of FIG. 3 expressed using R, G, B components and transformed and show primary, secondary and tertiary components and mean and maximum bounding box and 1 standard deviation bounding box as they would appear prior to transformation according to an embodiment of the present invention;

FIG. 16 illustrates a process of characterising colour information in pixels according to an embodiment of the present invention;

FIG. 17 illustrates an augmented reality system which applies machine colour recognition according to an embodiment of the present invention of FIGS. 1 and 16;

FIG. 18 illustrates a process of media generation involving a 3-D model which is used with colour recognition according to the embodiment of the present invention;

FIG. 19 illustrates a page image and reference image used with the embodiment of the present invention of FIGS. 1 to 18;

FIG. 20 illustrates a page image and reference image used with the embodiment of the present invention of FIGS. 1 to 18;

FIG. 21 illustrates an augmented reality system according to an alternative embodiment of the present invention;

FIG. 22 illustrates a system for generating colour characterisation model data from example colour images; and

FIG. 23 illustrates a system capable of machine characterisation of colour in a subject image.

Further aspects of the invention will become apparent from the following description of the invention which is given by way of example only of particular embodiments.

### BEST MODES FOR CARRYING OUT THE INVENTION

Embodiments of the invention relating to devices, systems and processes for machine colour or characterisation or recognition and categorisation will now be described.

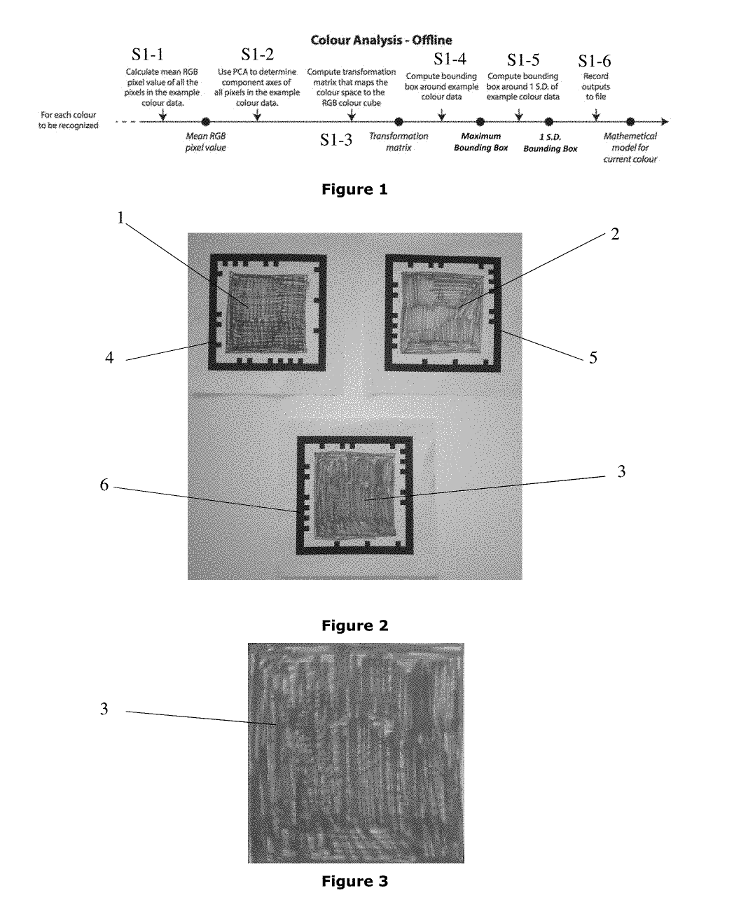

FIG. 1 illustrates a process for generating colour model data. The model data may define a model which is specific to an example colour that a user wishes to be recognised by a computer system of application running on the system. The colour to be recognised can serve as a colour category, into which colour information included in media data which is input to the application can be categorised. In this embodiment of the invention, the category of colour in the media is used to invoke actions in the application to control the application and adjust media generated by the application. In this embodiment actions are associated with areas of a reference drawing captured in an image so that areas of the drawing recognised in the captured image can be associated with various actions depending on the category of colour that appears in that area. Also in this embodiment areas in a reference drawing are associated with a 3-D model or avatar that is used by the application to generate media so that colour added to areas in a reference drawing and captured in an input image can be used to invoke actions that are specific to parts of the 3-D model.

The generation of colour model data may be understood by the reader and referred to below as off-line colour analysis. This offline process generates colour model data carrying colour models which can be used to categorize defined colours. The colours are defined by example images containing them.

The process of generating colour models begins with capturing digital images containing examples of each colour to be categorized. For example, if creating a model which describes a given “red” colour, several images of a red square would be captured under different lighting conditions, by different camera devices.

These images are then processed using the following algorithm illustrated in FIGS. 1 to 15.

Steps S1-1 to S1-6 of FIG. 1 are performed for each colour which is selected to be recognized. These steps train the system to recognize given colours or, more precisely, to represent colours as categories may be used for machine colour analysis.

Three example colours are shown in FIG. 2. The example colours a blue 1, a green 2 and a red 3 have been drawn using a colour marker within respective frame markers, or defined areas, of a drawing to be captured in a digital image.

Distinct frame markers allows the system to know which example pixels are to be used to train the system for each respective which colour category. These pixels carry colour information on examples of colours selected for recognition and will be referred to as example pixels. FIG. 3 shows a reference image for the example pixels for the ‘red’ category′ extracted using the frame markers.

At step S1-1 a mean Red Green Blue (RGB) pixel value of all the pixels in the example colour media data is computed. For each example pixel of a colour to be recognised, values of the red, green and blue components are summed and divided by the count of pixels to determine the mean red, green and blue values for the pixels.

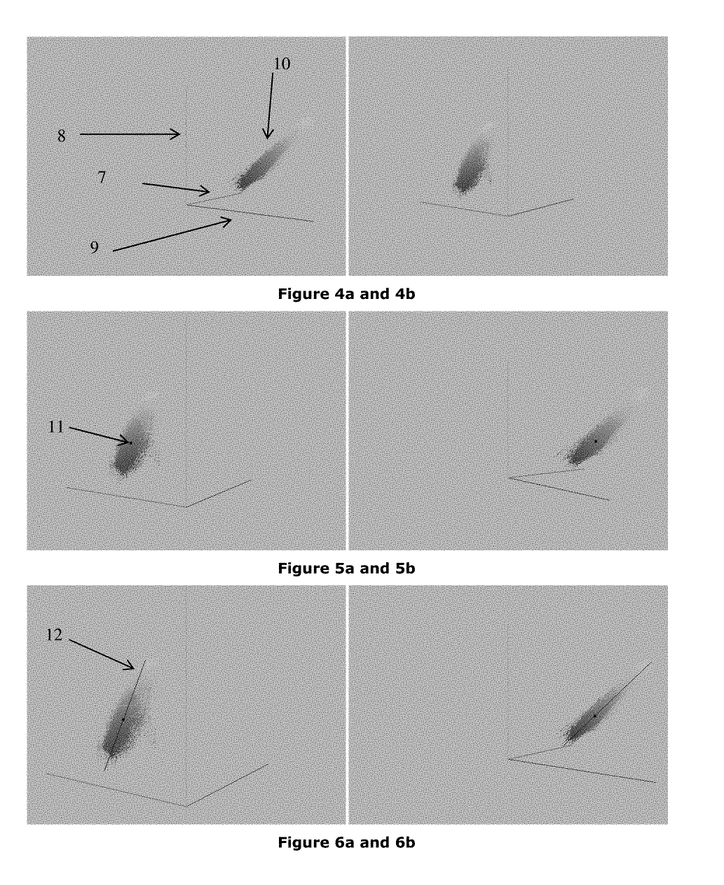

FIGS. 4a and 4b show the pixels 10 from the reference image of FIG. 3 expressed, or plotted, using R, G, B components, 7, 8 and 9 respectively. The colour components represent the R, G, B colour cube. The lot of example pixels of the example ‘red’ of FIG. 3 form a scatter within the R, G, B cube.

FIGS. 5a and 5b show the mean of the example pixels 10 expressed using R, G, B components.

In this step the computed mean Red, Green and Blue values 11 for all example pixels are stored for a given colour category to be recognized.

At step S1-2 component axes defining a colour space for the example pixels are computed.

In this embodiment, Principle Component Analysis (PCA) is used in this step to determine component axes of all pixels in the example pixels of a colour category.

Principal Component Analysis is then performed to determine the principal, secondary and tertiary component axes for the data.

These axes represent the longest dimension, second longest dimension, and dimension orthogonal to these dimensions in the 3D space, respectively.

FIGS. 6a and 6b show the principle component axis 12, as the longest axis, of the example pixels of the colour category for the reference image of FIG. 3.

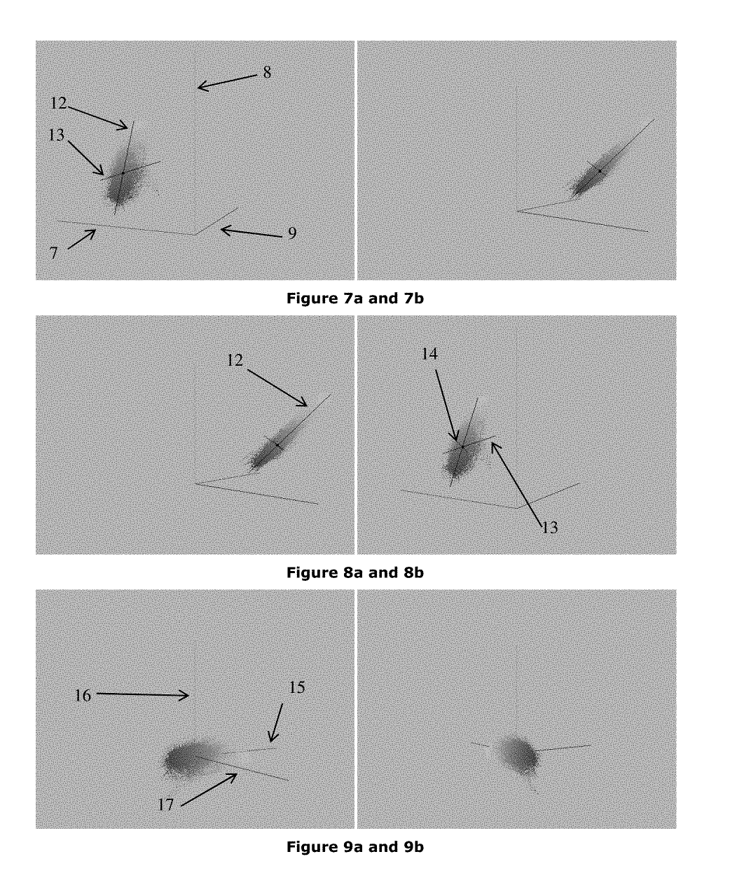

FIGS. 7a and 7b show the secondary principle component axis 13, as the second longest, of the example pixels of the colour category for the reference image of FIG. 3.

FIGS. 8a and 8b shows the tertiary component axis 14, as the third longest, of the example pixels of the colour category for the reference image of FIG. 3.

Step 1-3: A transformation matrix is computed to align the principle, secondary and tertiary axes to X, Y and Z axes of a 3-D colour space with the mean at the origin of the 3-D space.

In this step the Red, Green and Blue colour components for each pixel are mapped into a 3D co-ordinate system as the X, Y and Z co-ordinates respectively. This coordinate system defines a colour space which will be used to define constraints for machine decisions and to relate pixels to those constraints and will be recognized by the reader as a reference colour space.

In this example the transformation matrix maps the principal, secondary and tertiary component axes computed in the previous step to the R, G and B axes respectively. The transformation matrix is computed to transform the colour space defined by the principal, secondary and tertiary component axes such that the longest dimension lies along the X axis 15, the second longest lies along the Y axis, and the third longest lies along the Z axis. The transformation is also computed such that the mean RGB pixel value is mapped to the origin of the colour cube. The pixels 10 are referred to as transformed pixels 18′ once the transformation has been applied.

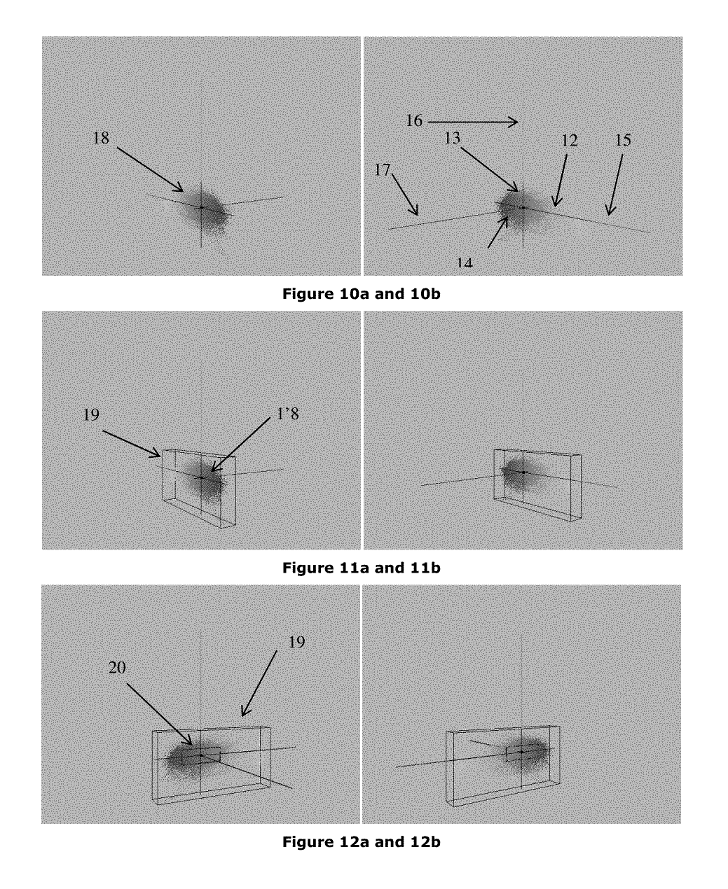

FIGS. 9a and 9b compared to FIGS. 10a and 10b, if overlayed, show alignment of the principle 12, secondary 13 and tertiary 14 component axes and the X 15, Y 16, and Z 17 axes respectively.

At this step also the transformation matrix is stored.

Step 1-4: A maximum bounding box 19 around the example colour data 18 is computed.

Using the Transformation matrix computed in the previous step, all pixels in the example data are transformed so that the longest dimension in the colour space lies along the X axis 15, the second longest lies along the Y axis 16, and the third longest lies along the Z axis 17. Each transformed pixel 18 is then iterated through, in a computational loop for example, to determine the minimum and maximum X, Y and Z values in the transformed space. These minimum and maximum values are used to define the bounding box that includes every pixel 18 in the example colour data (Maximum Bounding Box). The reader will recognize the bounding box as an example of a mathematical constraint. The reader will also recognize that the transformation has simplified the definition of the colour model in the transformed space. The bounding box 19 is defined in the R, G, B cube which serves as a standardized space for all colours to be recognized.

FIGS. 11a and 11b, 12 a and 12 b show a maximum bounding box.

This step stores the bounding box bounding box which includes every pixel in the example colour data (Maximum Bounding Box).

Step 1-5: A bounding box 20 around 1 Standard Deviation from the mean of example colour pixels is computed.

Using the transformed pixel data from the last step, the standard deviation of the example data values is calculated for the X, Y and Z axes. A second bounding box 20 is defined using the negative and positive first standard deviation values in the X, Y and Z axes (1 S.D. Bounding Box). This will be recognized by the reader as a bounding box which defines a probability or confidence interval for the example pixels, assuming a given statistical distribution. In this case the statistical distribution is Gaussean.

In this step also the Bounding Box that includes the first standard deviation of all pixels in the example colour data (1 S.D. Bounding Box) is stored.

Step 1-6: Outputs of colour model generation steps are stored to file as colour model data.

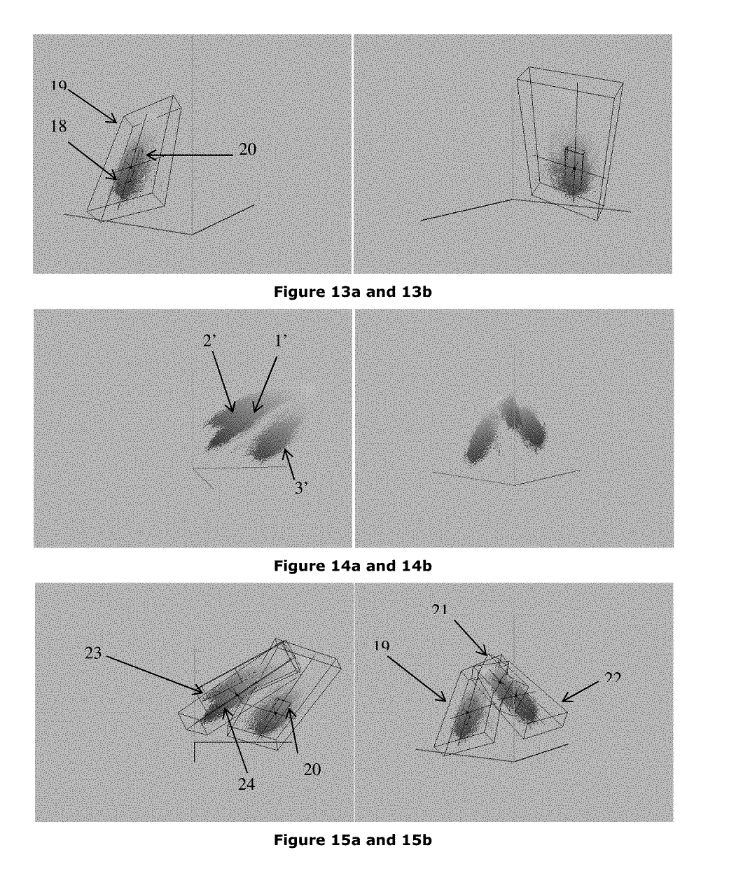

FIGS. 13a and 13b show the bounding boxes 19 and 20 after an inverse transformation with the transformation matrix into the space represented by R, G and B components of the pixel and illustrating that the definition of the bounding boxes would be more complex without the transformation.

FIGS. 14a and 14b show the scatter or example pixels 1′, 2′ and 3′ of all three example colours 1, 2 and 3 in the original R, G, B component space.

For each colour to be recognized, colour model data is stored. The colour model data for each colour carries information on the mean Red, Green and Blue values for all example pixels, the transformation matrix, the bounding box which includes every pixel in the example colour data, and the bounding box which includes the first standard deviation of all pixels in the example colour data. The colour model data carries a Mathematical Model for the colour to be recognized. This data is recorded into a file to be used in a colour analysis online process.

FIGS. 15a and 15b show the bounding boxes 19, 21 and 22, 20, 23 and 24 and means (not indicated) representing a colour model for each example colour to be recognized, or used as a colour category, after inverse transformation in the R, G, B component space.

This step stores in a file the colour model data carrying a colour model for each colour to be recognised. The reader may recognize the colour data as storing a mathematical model. The reader will also recognize the bounding boxes as constraints.

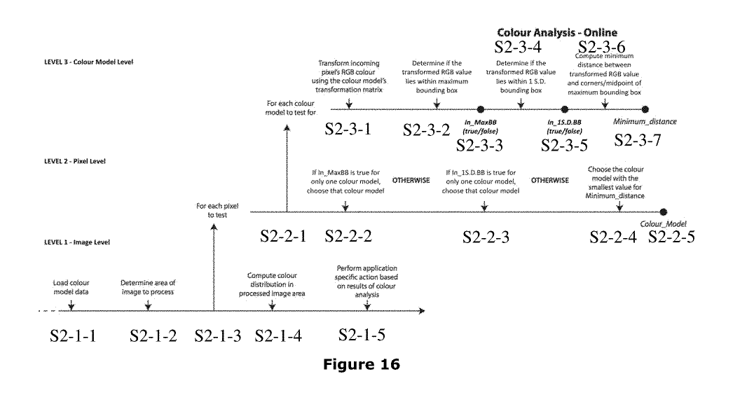

An online process for colour characterisation will now be described with reference to FIG. 16. The colour categorization process uses colour model data to recognize colours in media data, such as digital images or video streams, by identifying a colour category for a digital image, or area within a digital image.

The mathematical models which were created as part of the offline process illustrated in FIG. 1 are used to identify colour categories for defined pixels in a image or live video stream. The output of the online process is a list of colours which were categorised, and the relative amounts of each colour present in the image, which can then be used to trigger certain events or behaviours or invoke actions in an application.

FIG. 16 shows a process for online colour analysis as a three-level algorithm as described below.

Level 1 is performed on a captured image. This level has steps S2-1-1 to S2-1-5.

At Step S2-1-1, the colour model data for each colour which is to be recognised in the captured image is loaded. This colour model data is generated and stored in the offline process. In this embodiment the colour model data contains the mean Red, Green and Blue values, the transformation matrix, the maximum bounding box, and the one standard deviation bounding box.

At step S2-1-2 the area of image to process is selected. In this embodiment colour characterisation is performed for every pixel in a selected area of the captured image. For the area of the image to process, each pixel is extracted.

At step S2-1-3 a colour category is determined for each pixel in the selected area of the image. A colour category is identified for the pixel using the algorithm at Level 2, which will is described below and will be referred to as the Pixel Level.

At step S2-1-4, a colour distribution of the selected area of the image to be processed is computed. In this embodiment, the percentage of pixels in each image area that has the each colour category identified is computed and stored. In this embodiment therefore, the percentages of each colour category in a selected area of the image will be stored.

At step S2-1-5, an application specific action is performed or invoked dependent on the data stored at S2-1-5.

In this embodiment specific actions or events are invoked occur dependent on the colour distribution in each area. One simple example is playing one noise if a selected area is mostly red and a different noise if the area is mostly blue. Another more complex example is to animate the head of a 3-D model based on the amount of green, the arms based on the amount of blue, and the legs based on the amount of red. In this example, the area selected for colour characterisation has a stored association with areas in a reference image used to select or define the area in an image.

Level 2 of the algorithm involves steps S2-2-1 to S2-2-5. These steps are performed on performed on pixels selected in the level 1 algorithm. The algorithms at Level 2 is a decision algorithm which categorises colour information in the pixel using the by determining properties for pixels dependent on a colour model stored in the offline process illustrated in FIG. 1. The determination of properties is described as a Level 3 algorithm below.

In Step S2-2-1 the properties of the pixel dependent on a colour model are determined by the algorithm of Level 3. This is recognizing a colour in a pixel. For each colour category properties for the pixel are determined using a colour model. These properties include whether the colour information in the pixel is contained in the Maximum Bounding Box, whether it is contained in the 1 S.D. Bounding Box, and the minimum distance between the colour information in the pixel and the Maximum Bounding Box and the mean. The reader will recognize that if the pixel is outside of the bounds of all colour models, it will find the closest enclosing model, but if it is contained within 2 colour models hopefully the one with the closer mean will be the correct colour.

The category for a colour is identified using a_properties determined dependent on the colour model. This is performed for the colour model of each colour category. For each colour model, the pixel will be assigned a colour category using the logic in Steps S2-2-2 to S2-2-4.

At step S2-2-2, a specific colour category is assigned to a pixel if the pixel is contained in the Maximum Bounding Box of the colour model for one and only one colour category.

Otherwise at step S2-2-3 a specific colour category is assigned if the pixel is contained in the 1 S.D. Bounding Box of the colour model of one and only one colour category.

Otherwise at step S2-2-4 a specific colour category is assigned based on which colour model provides the smallest of the minimum distance between the pixel and the Maximum Bounding Box and the minimum distance between the pixel and the mean.

At step S2-2-5 the algorithm stores the colour category which steps S2-2-2 to S2-2-4 determine is the best match for the colour information of the pixel.

Level 3 is performed on pixels selected at Step S2-2-1 of the algorithm illustrated in FIG. 16 and involves steps S2-3-1 to S2-3-7. Level 3 is performed for each colour category.

At step S2-3-1 each pixel selected at Level 2 is transformed using the respective transformation matrix. This transformation is applied to RGB colour components of the pixel.

The Red, Green and Blue components of the pixel are mapped into a 3D co-ordinate system as the X, Y and Z co-ordinates respectively. These values are then transformed using the transformation matrix of the respective colour model so that it can be easily compared to the colour model's bounding boxes.

At step S2-3-2 a determination or computation is made of whether the transformed RGB value lies within the Maximum Bounding Box of the respective colour model. This transformation maps the pixel, stored as R, G, B colour components to the colour space of the respective colour model.

With the red, green and blue components of the pixel transformed in the colour models 3D coordinate space as X, Y and Z respectively, the pixel can be related to the bounding box to determine whether the colour information represented by the pixel lies within the Maximum Bounding Box. In this embodiment this is tested by relating the transformed X, Y, Z values of the pixel to the maximum and minimum values of the X, Y, Z axes respectively which represent the Bounding Box. In this embodiment, the condition that the colour information of a pixel is within a bounding box if after operation by the transformation matrix the X value is between the minimum and maximum X values of the Maximum Bounding Box AND the Y value lays between the minimum and maximum Y values of the Maximum Bounding Box AND the Z value lays between the minimum and maximum Z values of the Maximum Bounding Box. If all these conditions are true, the transformed pixel is in the Maximum Bounding Box. If any of the conditions are false, the transformed RGB value is not in the Maximum Bounding Box.

At step S2-3-3 a value of true or false for the pixel associated with the Maximum Bounding box of the colour model is stored.

At step 2-3-4 a determination of whether the transformed R, G, B colour components of the pixel lie within the 1 S.D. bounding box is made.

With the R, G, B components of the pixel mapped to the 3D coordinate space as X, Y and Z after operation by the transformation matrix of the respective colour model, the colour information of the pixel, or the pixel, can be related to the 1 S.D. Bounding Box to determine whether the pixel is within that Bounding Box. In this embodiment the determination is made after transformation by testing whether the X value lays between the minimum and maximum X values of the 1 S.D. Bounding Box AND the Y value lays between the minimum and maximum Y values of the 1 S.D. Bounding Box AND the Z value lays between the minimum and maximum Z values of the 1 S.D. Bounding Box.

If all these conditions are true, the transformed RGB value is in the 1 S.D. Bounding Box, if any of the conditions are false, the transformed RGB value is not in the 1 S.D. Bounding Box.

At step S2-3-5 a true/false value for whether the transformed colour components of pixel are within the 1 S.D. Bounding Box is stored in association with the pixel and the respective colour model.

Alternatively, the test for whether a pixel fits a certain colour model bounding box can be expressed as follows.

First, a pixel is transformed using the transformation of the certain colour model. Then a test for whether the pixel is contained within one of the bounding boxes can be performed using the using the following equation

Pᵣ>=cmᵣₘᵢₙ AND Pᵣ<=cmᵣₘₐₓ AND

P_{g}>=cm_{gmin} AND P_{g}<=cm_{gmax} AND

P_{b}>=cm_{bmin} AND P_{b}<=cm_{bmax}

Where Pᵣ, P_{g} and P_{b} are the red, green and blue values of the pixels, and cmᵣₘᵢₙ, cm_{gmin} and cm_{bmin} are the minimum bounds for the red, green and blue axes of the colour model and cmᵣₘₐₓ, cm_{gmax} and cm_{bmax} are the maximum bounds of the red, green and blue axes of the colour model.

At Step S2-3-6 the minimum distance between transformed R, G, B colour components of the selected pixel and defined points of bounding boxes of a set of colour models is computed. The defined points may be corners or may be a mid-point of a given type of bounding box. This determines which colour model has a defined point of a bounding box which is closest in the R, G, B colour space to the colour information of the transformed pixel. Level 3 of the algorithm is applied on a per colour model basis, so the pixel will have been transformed using the transformation matrix specific to that colour model.

In this embodiment the Bounding Box used is the Maximum Bounding Box. After transformation of the colour components with the each respective transformation matrix the euclidean distance between the pixel and each of the eight corners and the mid-point of the Maximum Bounding Box is computed, and the minimum value is recorded. This value stores a record of how far away the transformed RGB for the pixel is away from being enclosed in the box.

At step S2-3-7 the minimum Euclidean distance between the transformed RGB value and the eight corners and mid-point of the Maximum Bounding Box of the respective colour model, and colour category, is stored for use by level 2 of the algorithm illustrated in FIG. 16.

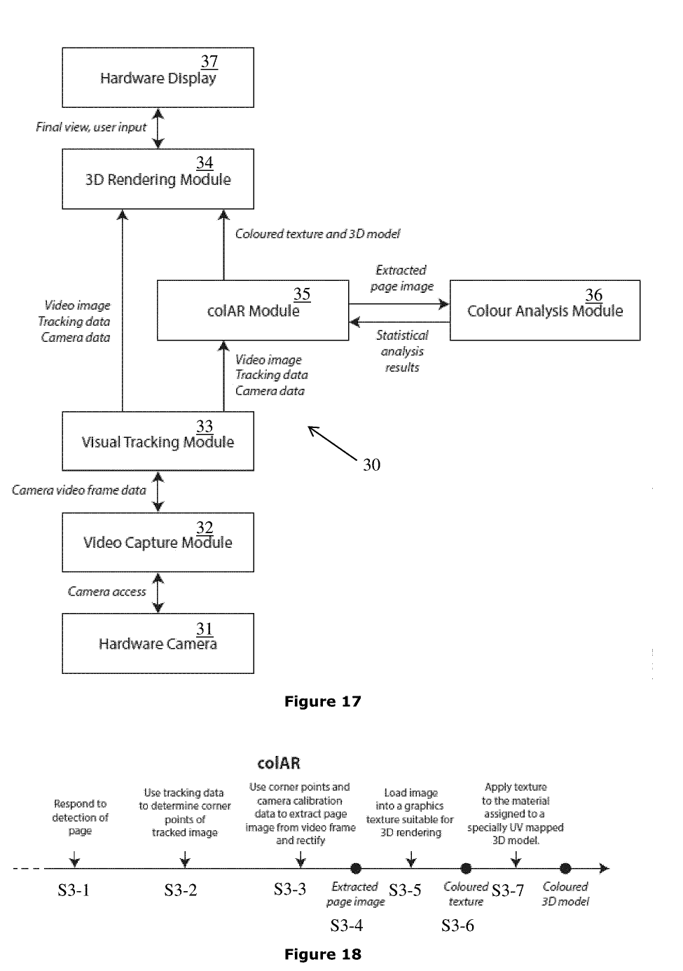

A computer system 30 which uses colour recognition according to an embodiment of the present invention is shown in FIG. 17. A hardware camera 31 is in communication with a video capture module 32 and operable to capture video as media data that includes an image of a page.

The video capture module is operable to communicate camera video frame data, or media data, to a visual tracking module 33 which tracks the image and accounts for the pose of the hardware camera with respect to the page, for example.

The visual tracking module communicates video image tracking data and camera data to 3-D rendering module 34 to place the image in a scene. As the reader will be aware the inputs to the 3-D rendering module are the “pose” of the tracked image with respect to the camera, to draw the 3-D content, and the image captured by the camera, for the video feed background.

The visual tracking module communicates video image tracking data and camera data to a texture extraction and mapping module 35 also.

The texture extraction and mapping module is operable to communicate an extracted page image to a machine colour recognition module 36 and to receive colour recognition data defining categories of colours identified in the image or selected parts of the image. The image contains a 2-D reference image, such as the outline of a bird or character in a game. The image also includes colours and texture added by a user to influence the augmented 3-D media generated by the system or to control characteristics of the augmented reality. The reader will recognise that the user is able to control the augmented reality computer system by the selection of colours added to the 2-D reference image.

The colour recognition module 36 of this embodiment performs the processes described with reference to FIGS. 1 and 16, involving generating colour models for a set of colours, or accessing pre-stored models, identifying categories of colour defined by the colour categories and outputting statistics on colour in an image or selected area in an image, such as the percentage of each colour category recognised in the area.

Finally, a Hardware module 37 displays the rendered augmented reality data and may capture user inputs for interactivity.

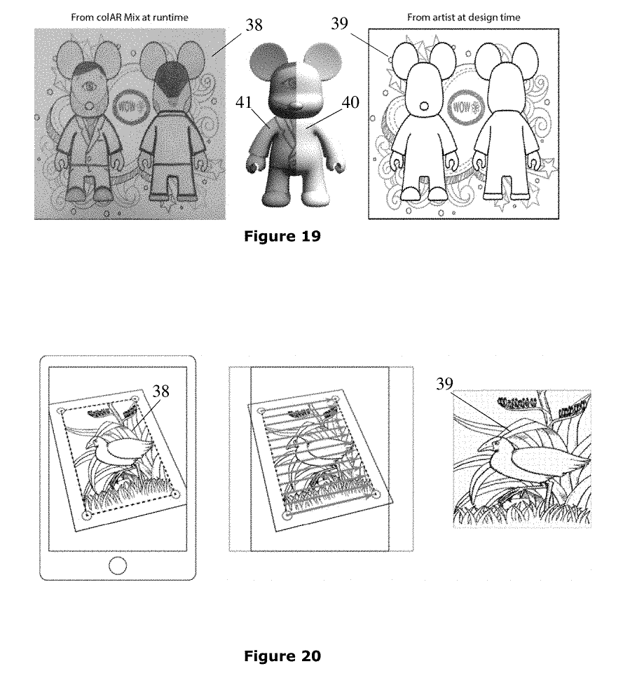

The augmented reality module applies the process illustrated in FIGS. 19 and 20 which will be described with reference to FIG. 18.

At Step S3-1 the texture extraction and mapping module responds to the detection of a page in the video image tracking data or camera data.

At step S3-2 tracking data is used to identify corner points of a tracked image.

At step S3-3 a reference image, such as the 2-D drawing shown in FIG. 20 is extracted from a video frame and rectified, as understood by the reader, using the corner points from S3-2 and camera calibration data.

At step S3-4 the extracted page image is stored.

At step S3-5 the stored image is loaded into a graphics 3-D texture suitable for rendering.

At step S3-6 the resultant coloured texture is assigned to a 3-D model, of a character for example, that is associated with the 2-D reference drawing, of the character for example, for UV mapping.

At step S3-7 a texture colour 3-D model which has colour and/or texture mapped from the extracted image to the model dependent on associations between the 2-D reference image and the 3-D model.

An example of colour characterisation applied to augmented reality according to an embodiment of the present invention will now be described.

In this example an application for a computer or mobile device example uses computer vision based augmented reality to track printed sheets and display virtual 3D scenes anchored to those sheets.

This application differs, and extends beyond other applications in that it does not simply use printed sheets for tracking.

The printed sheets used with this application are coloring pages as shown in FIG. 19 and FIG. 20. The application detects and tracks a page 38, and extracts an reference image 39 from the page 38. The application knows it's respective device's pose relative to the page, and the optical characteristics of the camera. Therefore, it is possible to rectify the image so that no matter the angle it is viewed from, it can be returned to its original unwarped representation.

3D content 40 generated and displayed on the page is texture mapped using the original page image 39. The complete surface 41 of a 3D model that is associated with a 2-D reference image 39 appearing in the colouring page 38 is textured, even where there is no point in the image that corresponds to a point on the 3-D model. For example, if the page depicts a teddy bear facing forwards, the colour for the back of the bear must come from somewhere in the page.

After extracting the coloring page image 38, or 2-D reference image 39, the application loads this image data into a texture that the graphics system can use, and applies it to the 3D model. The 3D model 40 now appears colored in, in the style and colors the user laid down on the coloring page. Specifically, UV mapping, or texture mapping, known to the reader, between areas in the 2-D image and associated areas on the 3-D model is performed. UV Mapping, or texture mapping, maps co-ordinates from a 2D page onto a 3D model.

This process allows each scene that pops up in an augmented reality display to customized based on the individual user's coloring choices, and is therefore unique. This is in contrast with conventional augmented reality apps that present the same 3D content to all users every time.

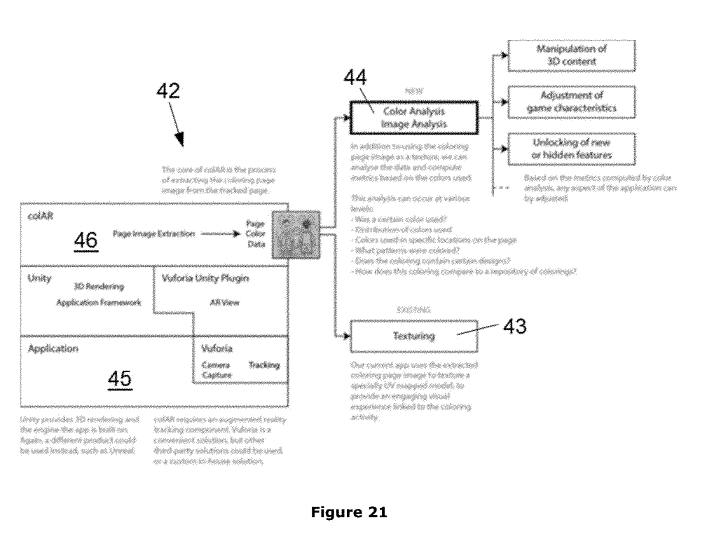

FIG. 21 illustrates a system 42 which uses machine colour recognition according to an embodiment of the present invention. The system 42 extracts a page image and applies it as a texture 43 to a 3-D model. The present embodiment of the invention also computes metrics 44 for colours. With these metrics 44, the system or a user of the system can dynamically adjust the behaviour of the scene and application 45 as a direct result of the user's unique colouring choices. The 3D model will then no longer simply look like the colouring, but it can take on characteristics to match. The metrics may be recognised as colour characterisation data.

The system comprises an application 46 to extract a 2-D reference image in the page image from the captured media data and to track the image and provide an augmented reality view that includes the image. From the page image from an image captured in media data an application that performs 3-D rendering, and an application that tracks a 2-D reference image in video stream and provides an augmented reality view and an application which provides the user with a user interface for an augmented reality experience.

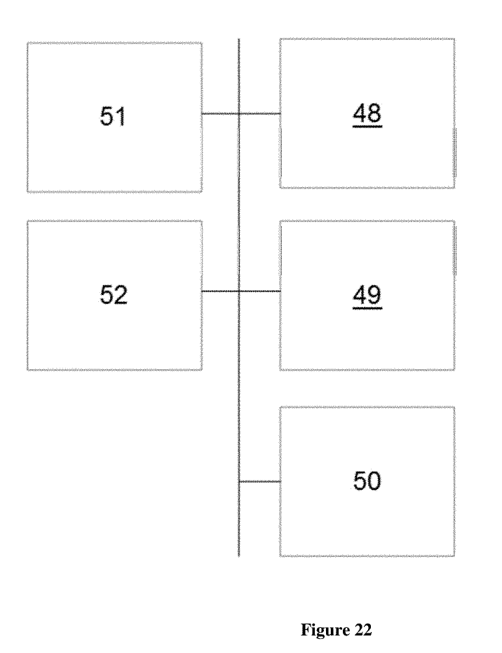

FIG. 22 illustrates a computer system 47 or processor which generates colour model data according to another embodiment of the present invention.

A media interface 48 is able to receive data carrying example colour information for an example image. The example image is an example in which an operator has applied a colour which is to be a category of colour.

A colour component module 49 is able to computes colour components of units of the media data, such as pixels in this example, to store each unit as colour components.

An axis module 50 is able to define axes for the stored units to define a first colour space.

A transformation module 51 is able to compute a transformation from the colour space to a standardised colour space.

A constraint module 52 is able to define a constraint in the standardised colour space dependent on the stored units of data. In this example, constraints are defined by confidence intervals assuming a statistical distribution of components of the units.

A colour model module 53 is able to generate colour model data carrying information on the constraint, or set of constraints, and a carrying information on a matrix transforming the first colour space to the standardized colour space.

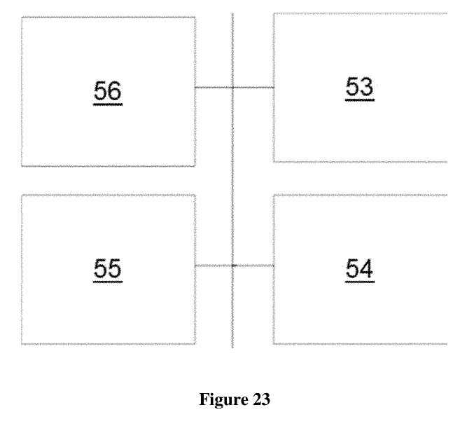

A processor or computer system for machine characterisation of colour accord to another embodiment of the present invention will now be described with reference to FIG. 23.

A colour model interface module 54 is able to receive colour model data for each of a set of colour categories. The colour model data is generated dependent on example colour data for each of a set of colour categories.

A subject image interface 55 is able to receive data capturing a subject image for colour characterisation.

A colour categorization module 56 is able to relate one or more units of data capturing the subject image to the colour model data of the set of colour categories to determine a colour category for the unit of subject image.

Further and additional embodiments will now be described.

Example invocations of actions by embodiments of the invention are described below.

An approach in battle games is for each character to be rated on a series of properties, such as firepower, speed, and shield. Each action taken in the game is based on these properties. Complex rules can govern how these values interact, but a simple example is: Character A will attack with power P, and Character B will defend with shield strength S. If P is enough to deplete S, then A wins.

Alternately, we could use the example of “ability classes”, as seen in games like where a “first type” character will be stronger than a “second type”, which is in turn stronger than a “third type”, who is stronger than the “first type”. It's a similar mechanic to paper-rock-scissors, but allows for a wider variety of classes, and these classes can easily be mapped to colours (red=fire, blue=water, green=grass, etc).

Often in games these properties are fixed for each character. Color Analysis would allow us to configure the properties for a character based on the way the user colored the character.

A character may gains certain features based on colors. When an artist creates a caricature, they exaggerate their subject's features to achieve a humorous effect. The degree of exaggeration is a sliding scale, which could be controlled via color. For example, the more red the user colors a creature's head red, the larger the head, whereas greener feet are smaller.

Visual effects within the scene can be chosen at runtime to match the colors used. For example, when red is used in a certain area, fire can erupt, but using blue would cause water to flow, and green could grow grass.

In alternative embodiments the off-line process described above is performed on-line.

In alternative embodiments the on-line process described above is performed off-line.

In alternative embodiments component steps or combinations of steps are performed in a combination of on-line and off-line depending on the specific application and computing and communications resources available for the specific application.

In alternative embodiments groups of pixels or pixels that have been spatially or otherwise filtered may be processed as units of data equivalent to pixels as described above.

In alternative embodiments the bounding box may be replaced by other examples of mathematical constraints.

In alternative embodiments online colour analysis is performed for every pixel in media input, such as a captured image or video stream.

In various alternative embodiments colour characterisation may be performed for various sections or sequences or subsets of input media data.

In some embodiments colour characterisation involves processing the pixels of defined units or a selected area to determine a category for the whole unit or area. In these embodiments the units or area may be treated as a pixel in the embodiment described with reference to FIGS. 1 and 16.

In some embodiments actions are invoked dependent on a colour category being identified in pixels in an image or selected area of the image or in media data input into the characterisation algorithm. This may be in combination with or irrespective of any distribution of colours.

In some embodiments the action invoked is not specific to any given application.

In alternative embodiments colour characterisation is determined using alternative logic or decision processes with the same properties determined dependent on colour models as illustrated with reference to FIG. 16.

In some embodiments subsets or combinations the properties may be used alone or with other properties known to the reader.

In alternative embodiments, alternative colour components to the to R, G, B colour components of pixels known to the reader are used.

In alternative embodiments alternative reference colour spaces to the R, G, B cube known to the reader are used.

Embodiments of the present invention provide a means for use of colour information by applications.

Embodiments of the present invention provide a means for machine characterisation of colour information in digital media in which colour information may be categorised.

Embodiments of the present invention provide a means to categorise colour information using colour categories defined by colour models generated by arbitrary colours. In some embodiments this may allow a user to choose the colours they would like to be used for colour categorisation. In some embodiments this may allow example colours to be recognised by an application or computer system. In some embodiments the colours that can be resolved as in digital media as belonging to separate categories can be relatively close. For example, colours that include common colour components may be resolved.

Embodiments of the invention may use known alternatives to a maximal and 1 S.D. bounding boxes. Embodiments may have 2 or more bounding boxes defined, 1 which contains ALL the example data, such as all the training pixels of example colour “RED”, and 1 which contains some subset of the example data, such as all pixels within 1 S.D. from the mean colour data. Assuming a Gaussian distribution and should be 68% of the pixels of the example colour. This may reduce the effect of “outlier” pixels, essentially “noise” in the training data as pixels which don't look very “red”. In some embodiments the maximal bounding box may not correspond to the largest spread along a component to which the principle axis is mapped, but may correspond to the spread after outlyers have been removed, or may correspond to a proportion of the largest spread, or may correspond to the spread along the axis of, say, the second, third or fourth furthest pixel from the origin or mean.

Embodiments of the present invention provide a means to provide machine characterisation of colour information in input media for interactive actions of applications.

Embodiments of the present invention to provide a means to provide machine characterisation of colour information in input media for the generation of media or at least to provide the public with a useful choice.

Embodiments of the present invention to provide a means to provide machine characterisation of colour information of selected areas of images in input media for applications.

Embodiments of the present invention provide a means to control applications or to control the user's experience of an application with information on colour included in images input to an application.

In additional embodiments any known logic to categorise a colour using information carried in a colour model data such as using bounding boxes, minimum distances, pixel means as illustrated above can be used in place of the logic described with reference to FIG. 16. For example, any of the information carried by colour model data may be omitted from the logic to categorise a colour, or any given information used may be replaced with an alternative known to the reader or derivable from parameters, data or information illustrated herein.

Embodiments of the invention have asset of software or hardware modules each operable to perform a step of the process of any of the embodiments described herein.

Embodiments of the present invention consist of stored executable instructions to perform computational processes, processes or steps as described in this document or to configure a computer, processor or device to provide software or operational modules operable to modules described in this specification or perform computational processes, processes or steps as described in this this document.

The reader will recognise that the processes and steps of embodiments described in this document include machine processes operating on data, code and files as required for specific implementations, these processes including reading, loading, storing, parsing, enumerating, instantiating, computing, machine calculation, transmitting, receiving, poling, providing data or code defining associations and other processes known to the reader.

The reader will recognise that the embodiments described herein may be stored as data and/or instructions in various known media such as magnetic, optical, cloud based media, or server media using a variety of storage, transmission formats and languages.

In some embodiments texture mapping is done offline as part of a model creation process—this is how we're able to texture parts of the model which have no corresponding point in the image (as mentioned above). During the online part, we simply copy the image into the texture buffer for that 3D object, and that texture buffer is used to texture the 3D model using the predefined mapping.

In some embodiments, the output of a colour characterisation process or module is characterisation data carrying information on the statistical analysis performed.

Some embodiments allow control of an application or computer system by applying colour to a subject image captured. In these embodiments the person applying colour may be recognized by the reader as an operator of the application or computer system running the application.

In some embodiments the equations or logic described herein to select a category of colour dependent on colour categoorisation data, constraints or bounding boxes are rules applied in a computer implemented process or by a processor, computer system or application.

To the reader, skilled in the art to which the invention relates, many changes in construction and widely differing embodiments and applications of the invention will suggest themselves without departing from the spirit or scope of the invention as defined in the appended claims. The disclosures and the descriptions herein are purely illustrative and are not intended to be in any sense limiting.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

What we claim is:

1. A process for a machine system to characterise colour in a subject image as a distribution across a set of arbitrary colour categories, the process comprising:
receiving colour model data for each of the arbitrary colour categories in the set, the colour model data generated dependent on example colour data capturing example images, the example images used to train the system to use each arbitrary colour category;
receiving data capturing a subject image for colour characterization;
relating one or more pixels within an area of the subject image to the colour model data to determine a said arbitrary colour category for said pixels,
determining colour distribution data for the selected area, the colour distribution data defining a distribution across the arbitrary colour categories for said pixels to characterise the colour in the selected area of the subject image.

2. The process of claim 1 wherein the colour model data defines a first volume in a colour space, the first volume defined for each of the arbitrary colour categories in the set, the first volume defined from pixels in the example colour data such that a given pixel has a defined probability of being with the first volume.

3. The process of claim 2 wherein the colour model data defines a second volume in a colour space, the second volume also defined for each of the arbitrary colour categories in the set and wherein the process comprises determining a said arbitrary colour category for said pixels by applying a set of rules dependent on relating the one or more pixels in the area to the first and second volumes defined in the colour model data.

4. The process of any one of claims 1 to 4 wherein an example image captures a drawing made with a colour marker to allow a user to train the system with the colour marker to use arbitrary colour categories to characterize colour in the subject image.

5. A process for machine characterisation of colour in a subject image from a set of example colours captured in example colour images, the process comprising:
receiving colour model data for each of a set of colour categories, the colour model data generated dependent on example colour data capturing example images of colour for each of a set of colour categories;
receiving data capturing a subject image for colour characterisation;
relating one or more units of data capturing the subject image to the colour model data of the set of colour categories to determine a colour category for the unit of subject image.

6. The process of machine characterisation of colour of claim 5, wherein the units of subject and/or example images are pixels to provide example pixels for each of the colour categories.

7. The process of machine characterisation of colour of claim 5 or claim 6, wherein the colour model data defined uses colour component axes.

8. The process of machine characterisation of colour of claim 5, 6 or 7 wherein the colour model data comprises a volume defined using colour component axes of a colour space.

9. The process of machine characterisation of colour of claim 8, wherein the colour model data comprises a volume defined using colour component axes of a colour space so as to contain the example pixels for each of the colour categories.

10. The process of machine characterisation of colour of any claim 8 or claim 9, wherein the colour model data comprises a volume defined using colour component axes of a colour space and defined by a statistical probability of containing example pixels for each of the colour categories for a defined distribution of example pixels.

11. The process of machine characterisation of colours of any one of claims 5 to 10, wherein relating the units of data capturing the subject image subject images to the colour model data comprises relating colour components of the unit of data capturing the subject image to the colour model defined using colour component axes.

12. The process of machine characterisation of claim 11 wherein relating the units of data capturing the subject image subject images to the colour model data further comprises determining which volume defined in the colour model contains each unit of data capturing the subject image.

13. The process of machine characterisation of claim 12, wherein the colour components are red, green and blue components of pixels.

14. The process of machine characterisation of colours of any one of claims 6 to 13, wherein the colour model data feature is a mean using red, green and blue colour components of a set of pixels of one or more example images.

15. A process of controlling an application running on a computer comprising the machine characterisation of any one of claims 5 to 14 and comprising invoking an action for the application dependent on the categorization of one or more units of data capturing the subject image subject to allow control of the application by application by an operator of colour to the subject image.

16. The process of claim 15 wherein an action invoked is associated with a selected area of a reference image identified in the subject image.

17. The process of claim 15 or claim 16 wherein actions invoked are associated with in the application associated with parts of a 3-D model associated with areas of a 2-D diagram captured in the image.

18. The process of any one of claims 5 to 17 comprising transforming colour components of the units of data captured for the subject image wherein the transformation is dependent on information on a transformation matrix carried in the colour model data.

19. A process comprising controlling a display for a user comprising the process of any one of claims 5 to 18.

20. A process of generating colour model data for an example or selected colour for use in machine recognition of colours, the process comprising:
receiving example media data carrying example colour information for an example image;
computing colour components of units of the media data to store each unit as colour components;
defining axes for the stored units to define a first colour space;
computing a transformation from the colour space to a standardised colour space;
defining a constraint in the standardised colour space dependent on the stored units;
generating colour model data carrying information on the bounding volume and carrying information on a matrix transforming the first colour space to the standardised colour space as colour data model generated from the example media data.

21. The process of claim 20 wherein the axes defined for the stored units are linearly uncorrelated.

22. A computer system operable to generate colour model data for an example colour or selected colour for use in machine recognition of colours, the process comprising:
an example media interface operable to receive data carrying example colour information for an example image;
a colour component module operable to compute colour components of units of the media data to store each unit as colour components;
an axis module operable to define component axes for the stored units to define a first colour space;
a transformation module operable to computing a transformation from the colour space to a standardised colour space;
a constraint module operable to define a constraint in the standardised colour space dependent on the stored units;
a colour model module operable to generate colour model data carrying information on the constraint and a carrying information on a matrix transforming the first colour space to the standardized colour space.

23. A computer system operable to characterisation colour comprising:
a colour model data interface operable to receive colour model data for each of a set of colour categories, the colour model data generated dependent on example colour data for each of a set of colour categories;
a subject image interface operable to receive data capturing a subject image for colour characterisation; and
a categorization interface operable to relate one or more units of data capturing the subject image to the colour model data of the set of colour categories to determine a colour category for the unit of subject image.
